(19) United States
(12) Patent Application Publication
(10) Pub. No.: US 2002/0144844 A1
(43) Pub. Date: Oct. 10, 2002

(54) Portable belt scale

(76) Inventors: Chester L. Nachtigal, Seattle, WA (US); Max F. Agoff, Seattle, WA (US)

Correspondence Address: Chester L. Nachtigal, 6810 31st AVE NE, SEATTLE, WA, 98117, US

(21) Appl. No.: 09/828,305

(22) Filed: Apr. 9, 2001

(51) Int. Cl. G01G 19/00

(52) U.S. Cl. 177/119

(57) ABSTRACT

A multi-purpose belt scale for measuring the weight of material being transported on a conveyor belt includes a pair of load cells with their extremities attached to and thereby supporting a weigh idler. The base of each load cell is attached to a crossbar with two mounting feet, each foot having several width-spaced mounting holes, thereby enabling attachment to a limited number of belt-width conveyors. Selection of the capacity of the load cells after the weighing application has been determined completes the multi-purpose applicability of the belt scale for belt widths and load weighing requirements. An alternative embodiment consists of a pair of mounting feet attached to sliding members that mate with the ends of the crossbar, thereby enabling the width spacing of the mounting feet to be attached to a variety of stringer widths. In both embodiments, the mounting feet are in pivoting contact with the stringers and have threaded lifting bolts to raise or lower the on-board weigh idler; thereby aligning the weigh idler carry roll with adjacent idler carry rolls.

The disclosure presents both a two-load-cell version and a single-load-cell version for lower cost. The two-load-cell version suspends the weigh idler from above its backbone, thereby significantly reducing error forces caused by overturning moments compared with gripping the weigh idler from beneath its backbone.

### FIELD OF INVENTION

This invention relates to conveyor belt weighing systems, and more particularly, to the mechanical structure and its weight-sensitive devices that support a short section of the belt with its material loading.

### BACKGROUND OF INVENTION AND PRIOR ART

The need for accurately measuring both the rate of material weight transported by a conveyor belt as well as the totalized weight that has been transported past the scale has long been recognized. Materials transported by conveyor belts and consequently needing to be measured range from huge flow rates encountered in the mining and aggregate production industries to comparatively miniscule flow rates in the sanitary foods and pharmaceuticals industries. Displayed flow rate is very useful and necessary to afford a plant operator the needed information in order to maximize his production rate by making appropriate changes as needed. Totalized weight is needed in order to provide data on plant yield and productivity over a period of time, such as one shift or one 24-hour day. Both of these data are generally available in modern belt scales.

A related need for measuring the flow rate of material transported by a conveyor belt is a machine called a weigh belt feeder, where the purpose of this machine is to deliver a flow rate slaved to another requirement, such as feeding granulated coal to the steam boiler of an electric power plant. Here the demand for electric power dictates the coal flow rate. The belt scale plays the role of a flow rate measurement device so that the plant control system has the necessary information to change this flow rate as needed to meet the momentary and changing demand for electric power. The need for totalized weight and the need for flow rate require similar components for the belt scale—a mechanical structure equipped with one or more weight measuring devices that support a short section of the loaded belt and produce a signal indicative of the magnitude of the load, a belt motion measuring device, and an electronic signal processor that combines the weight and motion signals and computes totalized weight, belt speed, and material weight flow rate. All three sets of components contribute to the error budget of the entire belt scale. However, it has generally been recognized that the greatest impact on belt scale accuracy resides in the design of the mechanical structure and its embedded weighing devices.

At least two categories of belt scale accuracy have been sought in the industrial application of belt scales: (a) highest accuracy for belt scales that are used to determine quantity of goods sold or exchanged; (b) lesser accuracy for belt scales that measure in-plant inventory and production rates. By far the largest number of belt scales are needed in category (b) where simplicity, general-purpose usefulness, and low cost are important criteria. Accuracy cannot be ignored but is not as demanding as in category (a). A third category of belt scale usage that is the target of this invention has received relatively little attention in the literature and by manufacturers of these systems: (c) deployment of a portable belt scale that will see service on more than one conveyor belt over its useful life. Two examples of such usage include the need for measuring the output yield and/or rate of a particular machine for a short time; intermittent use of two different conveyor belts operated one at a time and each requires measurement of the material being transported. For both of these applications, the most important criterion is ease of installation, de-installation, and re-installation of the belt scale while maintaining a modicum of accuracy.

Judging from the last several decades of patent activity, simplification of the mechanical structure has received much attention in the prior art as witnessed by U.S. Pat. Nos. 4,260,034, 5,111,896, 5,296,654, and 5,866,855. These patents all show belt scales without a structural crossbar member that, if present, would span the conveyor from one side to the other. FIGS. 1 and 2 show the two most recent patented two-piece weighframes in this series of inventions. Because the mechanical structures of these referenced belt scales are comprised of two pieces and therefore more complex to install, it is highly unlikely that any of these would be selected for a portable application where ease of transportability from one conveyor to another becomes an important and probably the most important criterion.

The mechanical structure and its attendant weighing device or devices will henceforth be called weighframe in this patent application. The weighing devices will be referred to as load cells. The assembly comprised of one horizontal roll (carry roll) and two inclined (troughing) rolls, and appropriate framework to connect all three rolls is variously called idler, idler assembly, or three-roll idler. The particular idler supported by the weighframe is called the weigh idler.

By far the most important user criterion in fulfilling category (c), a portable scale, is ease of installation. Only slightly less important secondary criteria are similar to those factors for category (b), namely: no interference with existing cross-braces of the conveyor, ease of alignment, no moving parts in the weighing mechanism, long life, and applicability to several different belt widths while still maintaining a satisfactory level of accuracy. The manufacturer of belt scales on the other hand has traditionally been concerned with ease of manufacturing, lowest production cost commensurate with intended accuracy, and ability to manufacture in advance of the specific order from a customer. Because conveyor belts are extant in many different widths, and a wide variety of full-scale material loading, a manufacturer has to inventory a very large number of weighframes if the design dictates that each belt width and each belt loading range requires a separate weighframe.

Ability to configure the weight capacity of a belt scale after its manufacture and at the time an order is received is highly important in maintaining low cost and flexibility in manufacturing. This later criterion can be achieved by installing load cells with the appropriate capacity for the particular user's needs. For the portable belt scale weighframe described in this patent application, it is entirely appropriate to offer more than one load cell assembly as needed to accommodate more than one belt loading range encountered in the various usage of the belt scale.

It was mentioned earlier that the most import criterion that a portable belt scale must satisfy is ease of installation, de-installation, and re-installation. A very close second criterion to be satisfied is that it can work with several different belt widths. This need has been addressed in the design of the Portable Scale via mounting feet that fit any of three different belt widths. Two different versions of such mounting feet are described elsewhere in this patent application.

It was also stated earlier that each of three sets of components has an effect on the overall accuracy. The design of the weighframe and its load cells is one set; a second set is the belt motion sensing components. This assembly is vulnerable to a variety of error-inducing factors, but the salient error associated with the belt motion sensor is its presence or absence. If present, the belt scale has information about and takes into account the modest variations in belt speed from empty to fully loaded—approximately one to two percent slow-down. If absent, the belt scale's electronic signal processor must be programmed with a constant belt speed, resulting in error during belt slow-down periods. However, since the application niche for a Portable Scale is somewhat less demanding in accuracy relative to the in-plant inventory or the for-trade niches, a Portable Scale can afford to operate with a programmed constant belt speed and thereby it can abandon the use of a belt motion sensor entirely. This simplification, while not attributable to any superior weighframe design, nevertheless greatly advances the goal of simple installation, de-installation, and re-installation.

The important matter of aligning the weighframe-load cell assembly's bending axis with the geometry of the weigh idler's carry roll is mentioned briefly in U.S. Pat. No. 5,296,654 (FIG. 1) and more extensively in U.S. Pat. No. 5,866,855 (FIG. 2). FIG. 3 illustrates the preferred relationship between these two entities. This same theme is carried forward to the current invention and patent application, illustrated by FIG. 6. Another theme articulated in U.S. Pat. No. 5,866,855 is the matter of an adjustment provision for matching the top of the weigh idler carry roll with the adjacent upstream and downstream idler carry rolls, a necessary step during equipment installation. U.S. Pat. No. 5,866,855 has threaded-bolt means for bringing about this alignment as does the current application. Other prior inventions cited here do not. Briefly summarizing the cited prior art inventions with respect to the stated objectives of the present Portable Scale:

1. A two-piece weighframe does not work well as a portable scale; too complicated to move easily;

2. Except for U.S. Pat. No. 5,866,855, no convenient means for vertically incrementing the weighframe with weigh idler assembly to achieve carry roll alignment with upstream and downstream idler carry rolls;

3. Except for U.S. Pat. Nos. 5,866,855 and 5,296,654, no recognition and/or serious attempt in the design phase to place the weigh idler on the weighframe in the correct relationship to minimize if not eliminate overturning torque errors;

4. The four cited prior art patents are aimed at in-plant inventory measurement; therefore they are not focused on the Portable Scale's comparatively lower accuracy application niche and thus the prior art inventions cannot afford the additional simplifying step of eliminating the belt motion sensor.

### OBJECTS AND ADVANTAGES

It is an object of this invention to provide a multi-purpose or portable belt scale weighframe that can easily be installed on a conveyor belt and later be de-installed and re-installed on another conveyor belt.

Another object is to create a weighframe that can be easily adapted to any one of a range of full-scale belt loading values after it has been manufactured.

An important object of this invention is that, although it has a crossbar, it can work with any one of a limited number of different belt widths.

Another object is to include a convenient means for raising or lowering the idler roller assembly attached to and supported by the scale so as to bring it into close alignment with the adjacent upstream and downstream fixed idler roll assemblies without the use of shims.

Still another object of the invention is to enable the user to align the scale weigh idler with the adjacent idler assemblies by passing a string line underneath the center carry rolls of these three idler assemblies without the line being impeded by any of the scale's component parts.

Another object is to position a three-roll idler assembly on a Portable Scale weighframe so that the carry roll axle is approximately in the plane that passes through the bending line of the scale and is parallel to the conveyor structural support stringers, thereby reducing errors due to torsional overturning effects.

### BRIEF DESCRIPTION OF FIGURES

FIG. 1 is a side view of a prior art no-crossbar weighframe where the weigh idler is secured by two cantilever beams, one on either side of the conveyor.

FIG. 2 is taken from a recently patented no-crossbar weighframe which shows a side view of one load beam and its attachment to the weigh idler.

FIG. 3, a recently patented prior art weighframe, shows the relationship between a belt loaded with material, the idler rolls supporting the belt, an end view of one load beam, and the best location for the plane through the weighframe's hinge line.

FIG. 4, from the current invention, shows an isometric view of one of two mounting feet attached to one of two support stringers and securing one end of the backbone of the weigh idler

FIG. 5 is a generic description of two different lever classes showing the spatial relationship between the fulcrum, the acting force and the reaction force.

FIG. 6 shows a variation of FIG. 4 wherein the multi-belt-width requirement is met by a telescoping mounting foot-crossbar arrangement.

FIG. 7 shows the relationship between a belt loaded with material, the idler rolls supporting the belt, an end view of one load cell, and the best location for the plane through the weighframe's hinge line relative to the idler support rolls and their burden.

FIG. 8 shows means for securing a weigh idler's angle-iron backbone to this invention's load cell with a V-block, an O-block, and a capture bolt and nut.

FIG. 9 is an alternative to the two-load-cell crossbar structure showing a single horizontal load cell supporting the weigh idler from beneath at its very center.

### DETAILED DESCRIPTION OF THE INVENTION

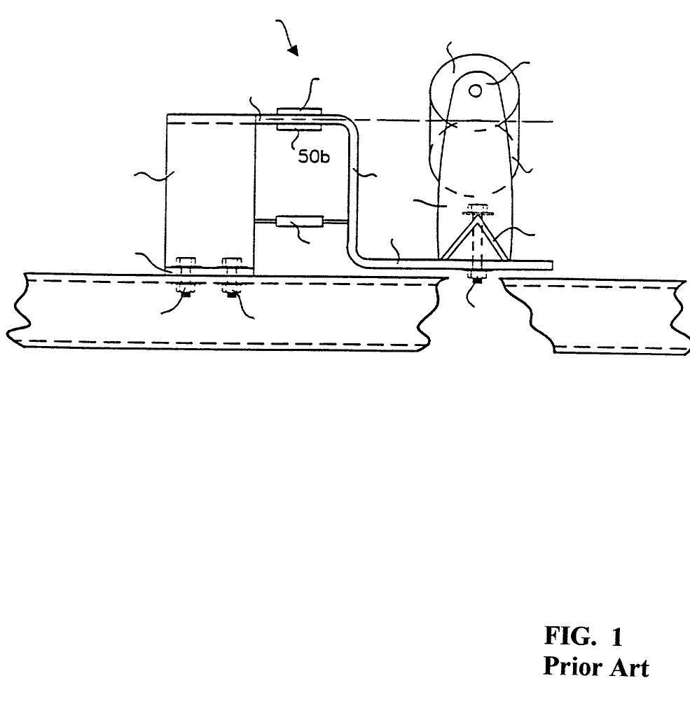

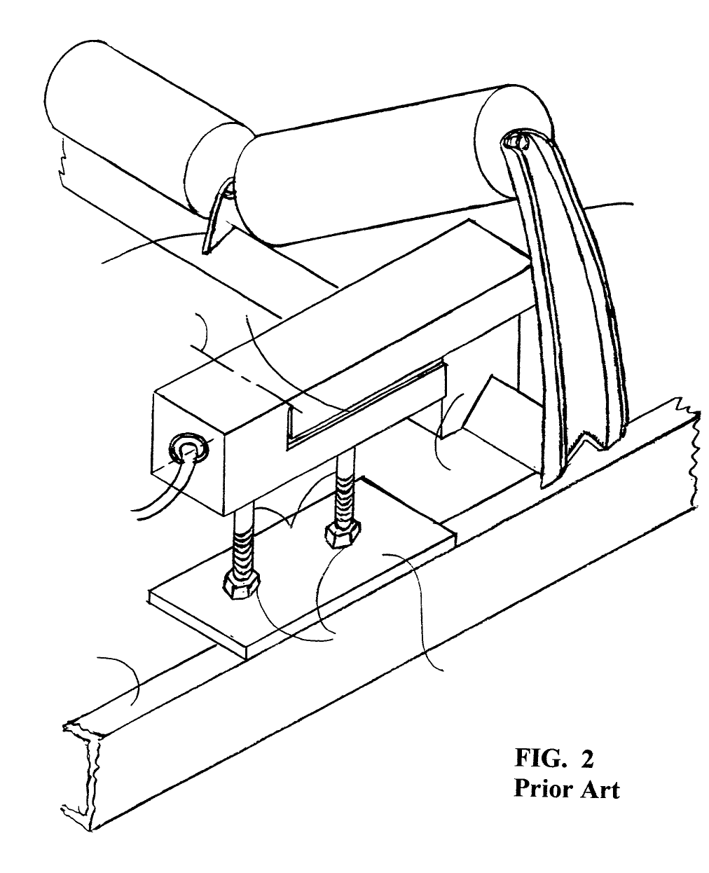

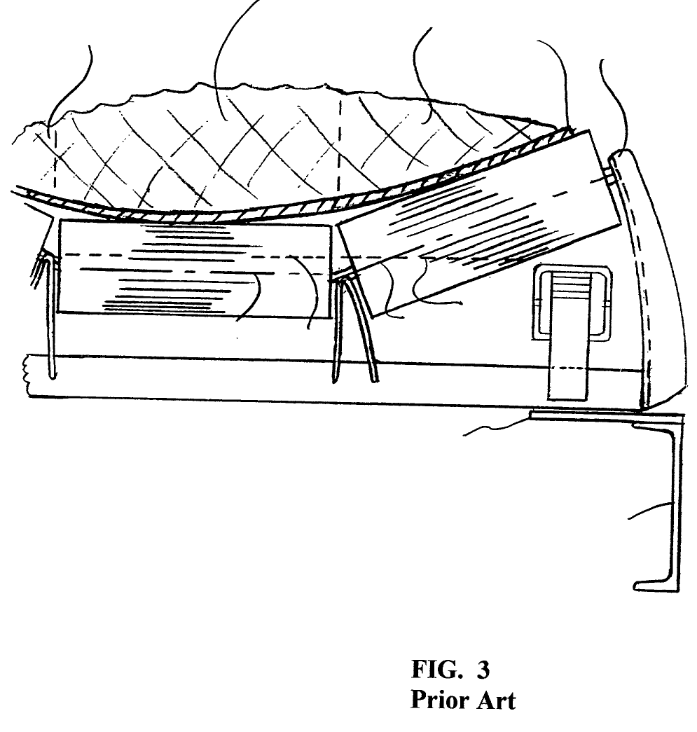

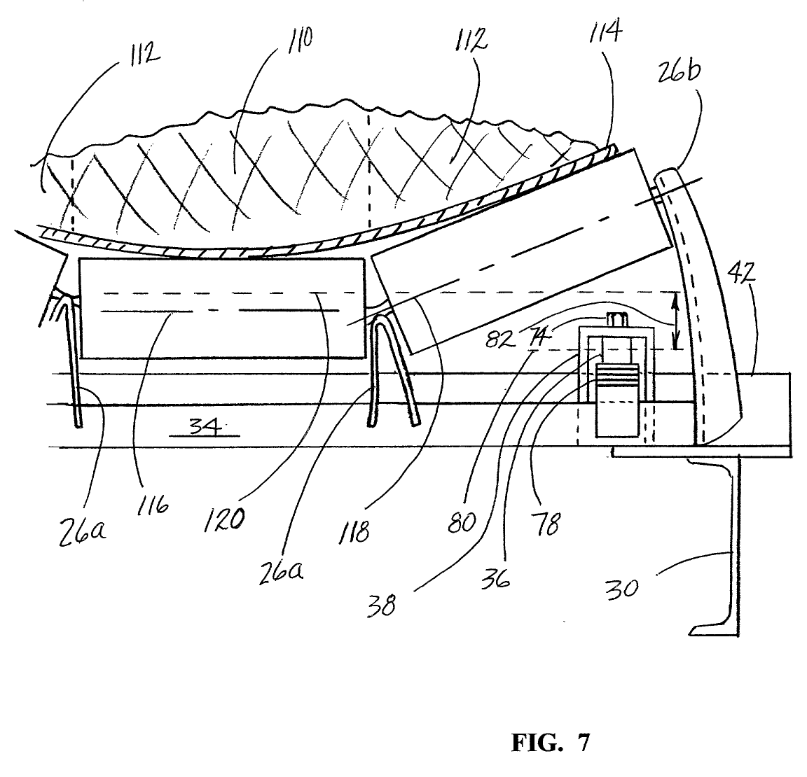

FIGS. 1 and 2 show the component arrangements of two prior art weighframes used to weigh material being transported by a troughing-idler belt conveyor. The weighframes shown in these figures share some of the features and objectives as well as have some significant differences with the current invention. FIGS. 1, 2, 3,4, and 6 all show only the weigh idler 20 supporting the belt 114 and its load 110, but it can readily be understood that the entire belt conveyor is comprised of uniformly spaced idlers like the one shown supported by the weighframe 32. The other regularly-spaced idlers, mounted on the parallel stringers 30 comprising the conveyor's structure, are aligned vertically with the weigh idler so that the belt 114 substantially forms a straight line from the belt's tail pulley to its discharge pulley. It can also be readily understood that the weight of the belt and its material load 110, 112 carried by these discretely spaced idlers is thereby transferred through them to the conveyor stringers 30. Furthermore, an industrial-grade belt of this nature can be expected to have imperfections, tears, and other protrusions that cause and create disturbance forces applied to the idler rolls in addition to the readily understood downward force due to the weight of the belt and its material loading. These additional forces are discussed in some detail in the context of FIG. 7. However, for reasons of accuracy, the prior art invention shown in FIG. 2 was considerably more focused on these disturbances than is the current invention.

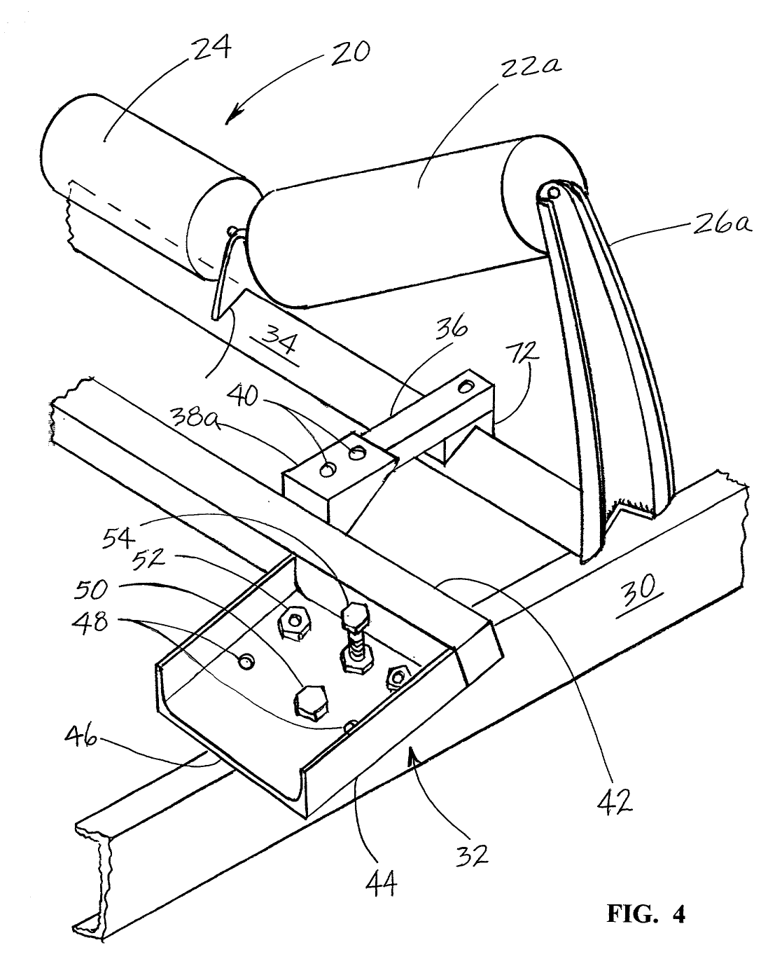

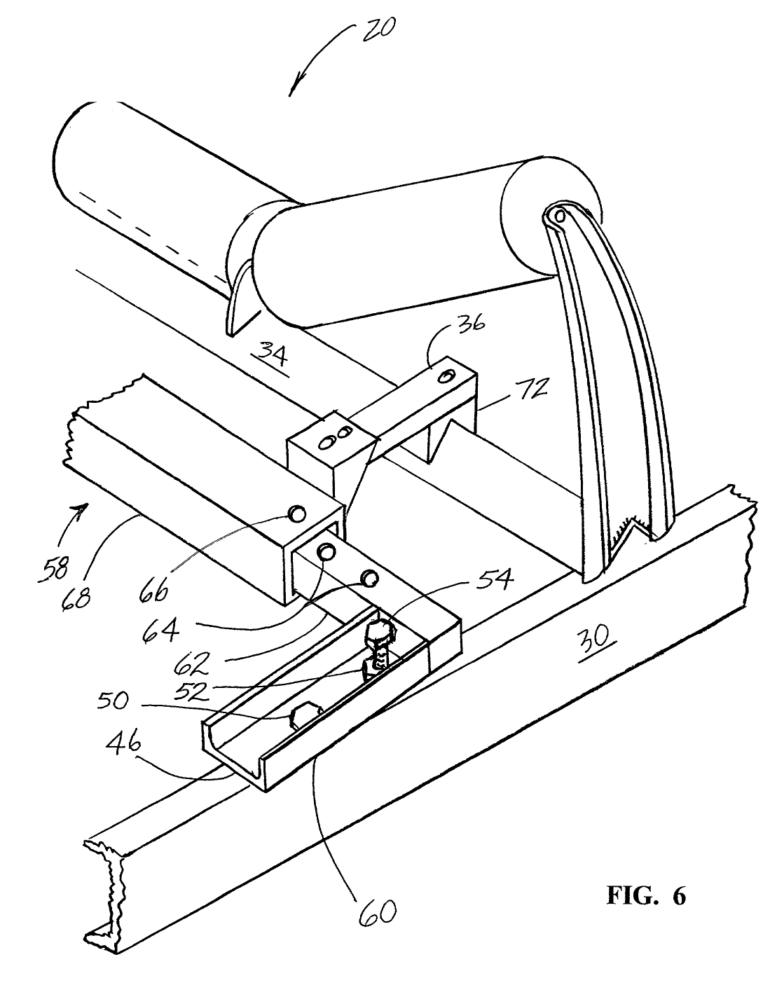

Both structures of the two different Portable Scale weighframes 32, 58, shown in FIGS. 4 and 6, have two principal attributes that make the Portable Scale very attractive to the supplier-manufacturer of belt scales: a) each weighframe's crossbar and mounting feet can accommodate a multiplicity of conveyor belt widths by virtue of the multiplicity of attachment holes in the mounting feet (FIG. 4), or by virtue of the telescoping crossbar (FIG. 6); b) the full-scale weight capacity can easily be selected after the weighframe has been completely manufactured by choosing the appropriate load cell weighing capacity at the time a customer places an order for a belt scale. Additional attributes that make this weighframe very attractive to the user that are at the heart of this invention are: c) installation simplicity and equally simple de-installation when moving it to another conveyor belt; d) designed to accommodate several different belt widths with no changes or modifications (24″, 30″, and 36″ belt widths are the three most common widths found in the aggregate industry for example); e) convenient means for raising or lowering the weigh idler 20 attached to and suspended by the two load cells 36 so as to bring about vertical alignment with upstream and downstream idlers; f) spatial arrangement between the weighframe and its load cell bending axis and the weigh idler carry roll 24 and its burden 110 so as to substantially reduce errors created by over-turning forces compared with other weighframes where the load cell(s) support the weigh idler at the bottom of its backbone 34.

FIG. 4 shows the right-hand end of a Portable Scale weighframe 32 supporting and securing the right-hand end of its weigh idler 20 at an extremity of one of its pair of load cells 36. The other extremity of the same load cell is attached to a load cell attachment bracket 38 to secure the load cell to the crossbar 42. A pair of wide mounting feet 44 are attached at the ends of the crossbar with their outboard edges (fulcrum line 46) resting on the top flanges of the conveyor support stringers 30. Each mounting foot 44 has a row of three attachment holes 48 with the middle hole occupied by a conveyor attachment bolt 50 that passes through the mounting foot 44 and through the top flange of the support stringer 30, thereby securing the weighframe 32 to the support stringers of the conveyor. The unused attachment holes are available for installation on a narrower or wider conveyor belt, thereby calling this invention a multi-purpose belt scale. A threaded lifting bolt 54 is engaged with threads 52 of the middle of three nuts attached to the mounting foot 44 and abuts the top flange of its respective support stringer 30.

When the lifting bolt is rotated clockwise, along with clockwise rotation of the other identical lifting bolt engaged in the threads of the left-hand mounting foot (not shown in FIG. 4) so as to cause a pivoting counter-clockwise rotation of the mounting foot about the fulcrum line 46, the weigh idler 20 is raised up to accomplish vertical alignment of the weigh idler carry roll 24 with the upstream and downstream adjacent idler carry rolls.

Similarly, rotating the lifting bolts 54 counterclockwise causes a clockwise pivot rotation of the weighframe 32 about the fulcrum line 46, thereby lowering the weigh idler 20.

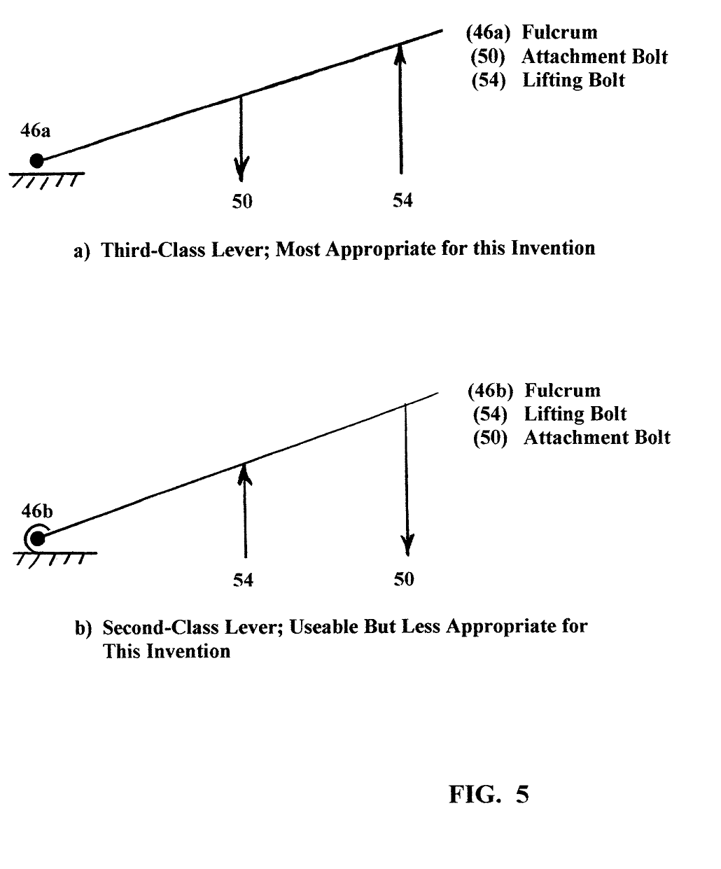

Referring to FIG. 5, two classes of levers are shown that have relevance to this Portable Scale weighframe invention. FIG. 5a) is a third-class lever and by virtue of locating the lifting effort (as provided by the lifting bolt 54) at the right-hand end and a restraining effort (supplied by the attachment bolt 50) between the fulcrum and the lifting effort, the fulcrum 46a need not be captured. FIG. 5b) on the other hand could also be employed at the mounting foot 44, but doing so would require capturing the fulcrum 46b. Thus the preferred lever model for the Portable Scale weighframe mounting foot is the third-class lever shown in FIG. 5a). Spacers similar to 78 could be inserted between the mounting foot 44 and the top flange of the support stringer 30 at 54 in FIGS. 5a), b) instead of a threaded lifting bolt to affect the height adjustment of the weigh idler 20. But a threaded lifting bolt 54 is substantially more convenient for both the manufacturer and the user.

Incorporating the third-class lever principle in the design of a belt scale weighframe's mounting feet has simplified its installation and reinstallation on another conveyor belt. The need for only two bolts to attach the weighframe 32 to conveyor support stringers 30 reduces the time spent in creating holes in the stringers as well as the fact that placing two holes at their correct relative locations is considerably easier than placing four holes as is often the case with other weighframes. Height adjustment has been simplified to only two lifting mechanisms. The presence of a crossbar ensures that the two load cells remain in their correct factory-determined locations with respect to each other and to the other weighframe components. The weighframe installation is carried out by first positioning it with respect to the targeted weigh idler without first removing the attachment bolts of the weigh idler. In fact, the weighframe could be secured to the weigh idler before removing its attachment bolts. All these factors contribute to its Portable Scale name.

FIG. 6 shows a weighframe 58 with an alternative design for the crossbar and mounting feet having the same multi-width belt accommodation as the weighframe 32 shown in FIG. 4. Each mounting foot has only a single location for an attachment bolt 50 and a single lifting bolt location 54. The mounting foot 60 is considerably narrower than the foot 44 shown in FIG. 4. The foot in FIG. 6 is joined to an extension 62 that mates with an appropriately sized crossbar 68 so that the two mounting feet can be slid out or into the crossbar and thereby create width spacing appropriate for the targeted conveyor belt width. Since conveyor support stringer side-to-side distances are standardized to certain dimensions, the foot extension holes 64 and the mating crossbar hole 66 can be manufactured in advance in accordance with the selected several belt widths that are to be accommodated by the weighframe 58. The description of how mounting feet 44 are modeled after a third-class lever principle shown in FIG. 5 is equally applicable to mounting feet 60.

Referring to FIG. 7, the weight of material 110, 112 on top of the belt 114 is transferred to weigh idler support rolls 22, 24 and to its backbone 34 via support brackets 26a, 26b, which in turn transfers the weight to the outboard ends of the load cells 36. Disturbance forces resulting from belt tears, imperfections, splices, and other factors act on the weigh idler rolls in a plane parallel to the conveyor support stringers 30. Because of the rising angles of the troughing rolls 22 and the material 112 carried by these two rolls, this disturbance force plane passes slightly above the carry roll axle 116, shown as line 120. The bending plane 80 of the weighframe with its attached load cells is parallel to the load cells 36 and passes through their center. Any disturbance force not in this plane causes load cell errors proportional to the distance away from this plane, indicated by the offset distance 82 in FIG. 7. This distance can be reduced by adding spacers at 78, thereby reducing load cell error due to the previously described disturbance forces. As mentioned earlier, at may not be important to reduce distance 82 to zero because this invention is more concerned with achieving simplicity of installation and reinstallation than concern with achieving highest obtainable accuracy as was prior art invention U.S. Pat. No. 5,866,855.

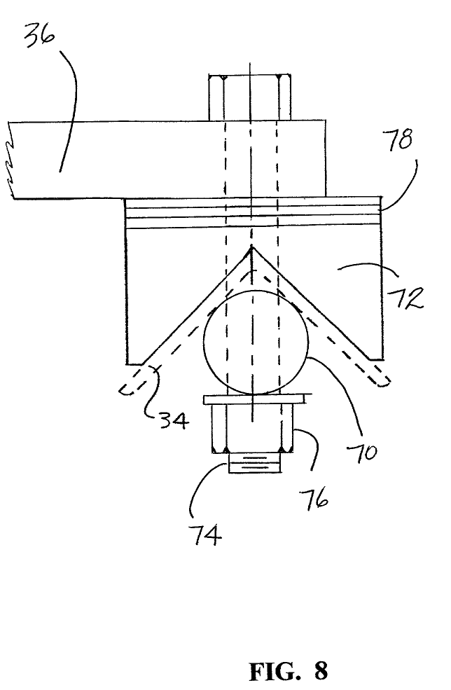

As shown in FIG. 8, the weigh idler backbone 34 is secured to the outer extremities of the load cells by threaded capture bolt 74. When nut 76 is tightened, backbone 34 is drawn up against V-block 72 by a cylindrical retainer block 70. Thus the weight of the material, having been transferred down to the weigh idler backbone 34, pulls down on the extremities of the load cells through bolt 74 and nut 76. Other shapes for the retainer block are envisioned, such as a sphere or a trapezoid. The components comprised of a V-block 72, a cylindrical block 70, and a capture bolt 74 with nut 76 capture the idler backbone 34 without the possibility of crushing the shape of this angle-iron member, thereby adding additional merit to this invention.

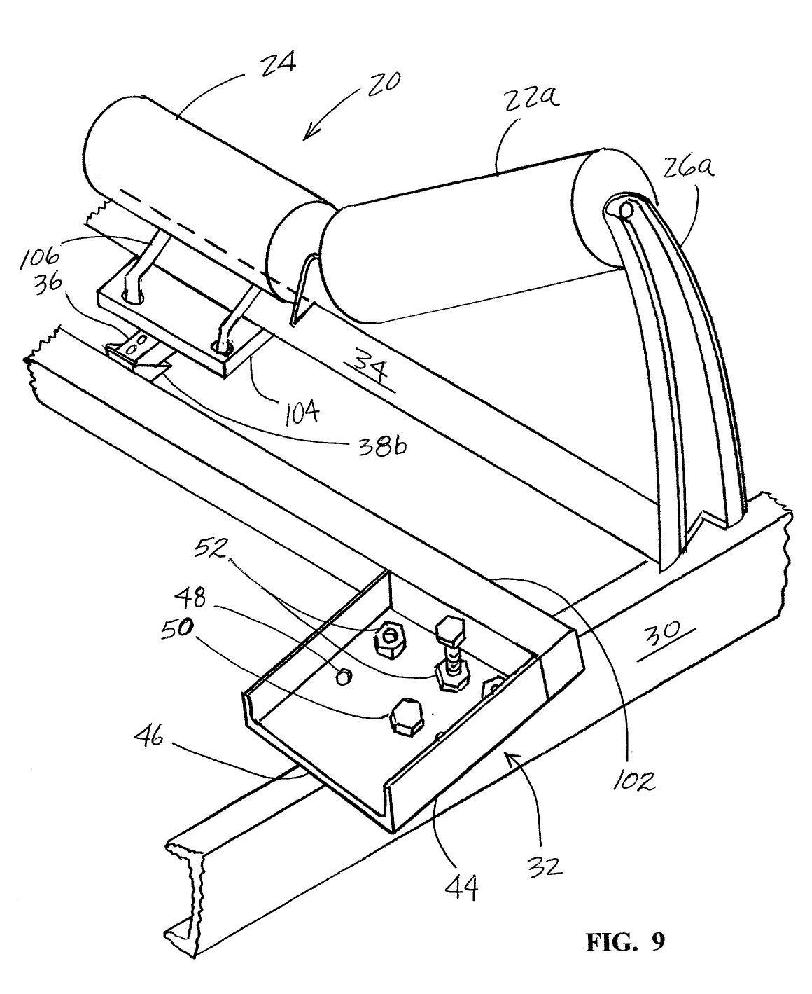

FIG. 9 shows a Portable Scale weighframe with a single load cell supporting the weigh idler at its center. Because the weigh idler carry roll 24 is in close proximity to the idler backbone 34, two V-bolts 106 and four retainer nuts 108 (not shown) are used to attach the backbone to the weigh idler mounting plate 104. This single-load-cell version of the Portable Scale results in reduced manufacturing cost.

### SUMMARY AND CONCLUSIONS

From the previous description the reader can readily understand that a multi-purpose portable belt scale weighframe with a crossbar and mounting feet that enable installation on a variety of belt width conveyors described herein combines the best interests of both the manufacturer and user. The pivot contact feature coupled with threaded lifting bolts uniquely combine to form a belt scale weighframe that is easy to install and to de-install for situating on another conveyor. While the various aspects of this invention have been carefully stated and illustrated, these specific renditions should not be construed as limitations to the scope of this invention. For example, the details of the extension and retraction of the mounting feet can be constructed in a variety of ways without departing from the essential concept of providing a weighframe suitable for a variety of belt widths. Accordingly, the scope of this invention should be determined not by the illustrated embodiment, but by the accompanying claims.

1. A multi-purpose conveyor belt scale weighframe for weighing material in transit on a conveyor belt, comprising:
a pair of parallel support stringers with a plurality of idlers providing rotatable support for a belt conveying means;
a pair of force sensing means each fixedly attached at one of their extremities to said weighframe and the other extremity of each of said force sensing means connected to a weigh idler;
a crossbar having a pair of attachment points for each of said pair of force sensing means;
a pair of mounting feet attached to said crossbar and in contact with said support stringers by a) pivot contact, by b) fixed attachment means, and by c) adjustment means whereby said weigh idler supported by said force sensing means can be lifted or lowered as required to achieve alignment of said weigh idler with adjacent said idlers fixedly supported by said parallel stringers, thereby creating a rapidly installable and re-locatable belt scale weighframe for material weighing;
selectable-width means whereby said weighframe can be attached to a multiplicity of stringer width spacings.

2. A multi-purpose belt scale weighframe according to claim 1 with a multiplicity of holes in each mounting foot to accommodate installing said weighframe on a multiplicity of belt conveyors, each having a different belt width.

3. A multi-purpose belt scale weighframe according to claim 1 comprised of two force sensing means so that the two said force sensing means together have the correct force capacity for the weight being carried by the belt.

4. A multi-purpose belt scale weighframe according to claim 3 wherein each force sensing means is comprised of a load cell.

5. Alternatively, a multi-purpose belt scale weighframe according to claim 1 with a pair of said mounting feet slideably connected to the extremities of said crossbar to accommodate a multiplicity of said conveyor belt widths, with locking means to secure said mounting feet in their desired position for each particular belt width, and with said mounting feet attached to said crossbar and in contact with said support stringers by a) pivot contact, by b) fixed attachment means, and by c) adjustment means whereby said weigh idler supported by said force sensing means can be lifted or lowered as required.

6. A multi-purpose belt scale weighframe according to claim 5 with a multiplicity of holes in the extension of each of said mounting feet and at least one corresponding hole in each extremity of said crossbar whereby the width between said mounting feet can be selected by said slideable means and with said locking means.

7. A multi-purpose belt scale weighframe according to claim 1 wherein said adjustment means to lift or lower said weigh idler is comprised of one or more threaded lifting bolts engaged with mating threads affixed to said mounting feet and butted against said support stringers so that by rotating said lifting bolts the said weigh idler is lifted or lowered and can thereby be vertically aligned with the carry rolls of adjacent idlers, thus eliminating the need for additional spacer elements to make the vertical adjustment.

8. A multi-purpose belt scale weighframe according to claim 1 wherein said crossbar, said mounting feet, and said weigh idler with its attachment fixtures are located entirely above the plane defined by the top surface of said parallel support stringers, thereby eliminating the need for modifying conveyor struts and braces passing between said parallel support stringers normally found in conveyors of this type.

8. A multi-purpose belt scale weighframe according to claim 1 wherein the weigh idler point of attachment to said force sensing means is comprised of a stack of shims and a capture bolt and nut so that the height of the weigh idler carry roll axle can be positioned in close vertical alignment to the load cell bending axis, thereby substantially eliminating measurement errors due to overturning forces and torques.

10. A multi-purpose belt scale weighframe according to claim 1 comprised of a low-profile crossbar with said mounting feet positioned on said support stringers but allowing a string line to pass above said low-profile crossbar and beneath the weigh idler carry roll, thereby enabling vertical alignment of the weigh idler carry roll with said adjacent idler carry rolls without lifting the conveyor belt from the weigh idler and adjacent idlers.

11. A multi-purpose conveyor belt scale weighframe for weighing material in transit on a conveyor belt, comprising:
a pair of parallel support stringers with a plurality of idlers providing rotatable support for a belt conveying means;
a single force sensing means with one of its extremities connected to a weigh idler;
a crossbar having one attachment point for the other extremity of said force sensing means;
a pair of mounting feet attached to said crossbar and in contact with said support stringers by a) pivot contact, by b) fixed attachment means, and by c) adjustment means whereby said weigh idler supported by said force sensing means can be lifted or lowered as required to achieve alignment of said weigh idler with adjacent said idlers fixedly supported by said parallel stringers, thereby creating a rapidly installable and re-locatable belt scale weighframe for material weighing;
selectable-width means whereby said weighframe can be attached to a multiplicity of stringer width spacings.

12. A multi-purpose belt scale weighframe according to claim 11 with a multiplicity of holes in each mounting foot to accommodate installing said weighframe on a multiplicity of belt conveyors, each having a different belt width.

13. A multi-purpose belt scale weighframe according to claim 11 comprised of force sensing means so that said force sensing means has the correct force capacity for the weight being carried by the belt.

14. A multi-purpose belt scale weighframe according to claim 13 wherein the force sensing means is comprised of a load cell.

15. Alternatively, a multi-purpose belt scale weighframe according to claim 11 with a pair of said mounting feet slideably connected to the extremities of said crossbar to accommodate a multiplicity of said conveyor belt widths, with locking means to secure said mounting feet in their desired position for each particular belt width, and with said mounting feet attached to said crossbar and in contact with said support stringers by a) pivot contact, by b) fixed attachment means, and by c) adjustment means whereby said weigh idler supported by said force sensing means can be lifted or lowered as required.

16. A multi-purpose belt scale weighframe according to claim 15 with a multiplicity of holes in the extension of each of said mounting feet and at least one corresponding hole in each extremity of said crossbar whereby the width between said mounting feet can be selected by said slideable means and with said locking means.

17. A multi-purpose belt scale weighframe according to claim 11 wherein said adjustment means to lift or lower said weigh idler is comprised of a threaded lifting bolt engaged with mating threads affixed to said mounting feet and butted against said support stringers so that by rotating said lifting bolt, said weigh idler can be vertically aligned with the carry rolls of adjacent idlers, thereby eliminating the need for additional spacer elements to make the vertical adjustment.

18. A multi-purpose belt scale weighframe according to claim 11 comprised of a low profile crossbar with said mounting feet positioned on said support stringers but allowing a string line to pass above said low-profile crossbar and beneath the weigh idler carry roll and thereby enable vertical alignment of the weigh idler carry roll with said adjacent idler carry rolls without lifting the conveyor belt from the weigh idler and adjacent idlers.
